(19) United States
(12) Patent Application Publication
(10) Pub. No.: US 2025/0314366 A1
(43) Pub. Date: Oct. 9, 2025

(54) LIGHT TUBE WITH A MULTI-LAYER OPTICAL MEDIUM STRUCTURE

(71) Applicant: Xiamen PVTECH Co., Ltd., Xiamen (CN)

(72) Inventors: LIANGLIANG CAO, Xiamen (CN); Jinsheng Li, Xiamen (CN); Youzhi Zhang, Xiamen (CN); Fuxing lu, Xiamen (CN)

(73) Assignee: Xiamen PVTECH Co. Ltd., Xiamen (CN)

(21) Appl. No.: 19/097,831

(22) Filed: Apr. 1, 2025

(30) Foreign Application Priority Data
Apr. 3, 2024 (CN) 202410404797.5

(51) Int. Cl. F21V 5/00; F21V 15/015; F21V 19/00; F21Y 103/10; F21Y 115/10

(52) U.S. Cl. CPC F21V 5/005; F21V 15/015; F21V 19/003; F21Y 2103/10; F21Y 2115/10

(57) ABSTRACT

A light tube includes an outer tube, an inner tube and a light source board. The inner tube is disposed inside the outer tube, and includes a mounting base, a first light adjustment portion, a second light adjustment portion, and a corrugated portion. The mounting base, the first light adjustment portion, and the second light adjustment portion are disposed on then inner wall of the inner tube, and the corrugated portion and the mounting base are disposed between the first light adjustment portion and the second light adjustment portion. The light source board is disposed on the mounting base. The corrugated portion corresponds to one side of the light source board. The first light adjustment portion has a plurality of first prism steps arranged in sequence, the second light adjustment portion has a plurality of second prism steps arranged in sequence, and the corrugated portion has a corrugated structure.

### BACKGROUND OF THE INVENTION

### 1. Field of the Invention

The present invention relates to a light tube, in particular to a light tube with a multi-layer optical medium structure.

### 2. Description of the Prior Art

Light tubes are common lighting devices that have been widely used in offices, industrial facilities, commercial spaces, schools, and other places to provide a bright and comfortable environment. Thus, the application of light tubes is extremely extensive. Due to advancements in technology, the efficiency of light tubes has also been significantly improved. However, currently available light tubes adopt a single-layer optical medium structure (single-layer light cover) without any additional optical adjustment mechanisms, so these light tubes still have many shortcomings that need to be addressed. For example, currently available light tubes are prone to producing severe light spots, which reduces the lighting effectiveness thereof. Additionally, due to factors such as structural design, currently available light tubes are susceptible to reduced light efficiency caused by scattering.

### SUMMARY OF THE INVENTION

One embodiment of the present invention provides a light tube with a multi-layer optical medium structure, which includes an outer tube, an inner tube and a light source board. The inner tube is disposed inside the outer tube, and includes a mounting base, a first light adjustment portion, a second light adjustment portion, and a corrugated portion. The mounting base, the first light adjustment portion, and the second light adjustment portion are disposed on then inner wall of the inner tube, and the corrugated portion and the mounting base are disposed between the first light adjustment portion and the second light adjustment portion. The light source board is disposed on the mounting base. The corrugated portion is corresponding to one side of the light source board. The first light adjustment portion has a plurality of first prism steps arranged in sequence, the second light adjustment portion has a plurality of second prism steps arranged in sequence, and the corrugated portion has a corrugated structure.

In one embodiment, the outer tube is cylindrical.

In one embodiment, the corrugated portion is disposed on the inner wall or outer wall of the inner tube.

In one embodiment, the corrugated portion is disposed on both the inner wall and outer wall of the inner tube.

In one embodiment, the corrugated structure includes a plurality of protrusion portions, and the top of each protrusion portion is arc-shaped.

In one embodiment, the corrugated structure further includes a plurality of flat portions, and the protrusion portions and the flat portions are alternately arranged.

In one embodiment, each first prism step has a first upper plane and a first lower plane connected to each other. The distance between the first upper plane and the light source board is less than the distance between the first lower plane and the light source board. Each of the second prism steps has a second upper plane and a second lower plane connected to each other. The distance between the second upper plane and the light source board is less than the distance between the second lower plane and the light source board.

In one embodiment, the first upper plane is parallel to the vertical reference plane. The first lower plane is parallel to the horizontal reference plane. The second upper plane is parallel to the vertical reference plane. The second lower plane is parallel to the horizontal reference plane.

In one embodiment, the first upper plane is not parallel to the vertical reference plane. The first lower plane is not parallel to the horizontal reference plane. The second upper plane is not parallel to the vertical reference plane. The second lower plane is not parallel to the horizontal reference plane.

In one embodiment, the first light adjustment portion and the second light adjustment portion are inclined surfaces, and the corrugated portion is arc-shaped.

The light tube with the multi-layer optical medium structure in accordance with the embodiments of the present invention may have the following advantages:
(1) In one embodiment of the present invention, the light tube includes an outer tube, an inner tube and a light source board. The inner tube is disposed inside the outer tube, and includes a mounting base, a first light adjustment portion, a second light adjustment portion, and a corrugated portion. The mounting base, the first light adjustment portion, and the second light adjustment portion are disposed on then inner wall of the inner tube, and the corrugated portion and the mounting base are disposed between the first light adjustment portion and the second light adjustment portion. The light source board is disposed on the mounting base. The corrugated portion is corresponding to one side of the light source board. The first light adjustment portion has a plurality of first prism steps arranged in sequence, the second light adjustment portion has a plurality of second prism steps arranged in sequence, and the corrugated portion has a corrugated structure. As described above, the light tube includes the outer tube and the embedded inner tube to form a multi-layer optical medium structure (double-layer light cover). This multi-layer optical medium structure allows the light emitted by the light source board to undergo two refractions, thereby achieving light concentration. This effectively enhances the illuminance in a specific direction (the direction of the corrugated portion) so as to significantly improve the lighting effect of the light tube. The aforementioned corrugated structure also enables uniform diffusion of light, so the light distribution can be more even.
(2) In one embodiment of the present invention, the first light adjustment portion and the second light adjustment portion of the inner tube of the light tube have a special structural design. The first light adjustment portion has a plurality of first prism steps arranged in sequence, and the second light adjustment portion has a plurality of second prism steps arranged in sequence. Each first prism step has a first upper plane and a first lower plane connected to each other. The distance between the first upper plane and the light source board is less than the distance between the first lower plane and the light source board. Each second prism step has a second upper plane and a second lower plane connected to each other. The distance between the second upper plane and the light source board is less than the distance between the second lower plane and the light source board. The structural design of the first light adjustment portion and the second light adjustment portion effectively concentrates the light emitted by the light source board toward the direction of the corrugated portion with a view to improving the light efficiency of the light tube. As a result, the performance of the light tube is significantly enhanced.
(3) In one embodiment of the present invention, the first light adjustment portion and the second light adjustment portion of the inner tube of the light tube have a special structural design, making them serrated in shape. This design effectively elongates the light spots generated by the light emitted from the light source board, preventing users from experiencing glare or other discomfort caused by the light spots. Therefore, the visual effect of the light from the light tube is greatly improved, which can effectively enhance the comfort of the environment. Thus, the light tube can be more comprehensive in application and more flexible in use.
(4) In one embodiment of the present invention, the corrugated portion of the inner tube of the light tube has the corrugated structure, which includes a plurality of protrusion portions and a plurality of flat portions. The aforementioned protrusion portions and flat portions are alternately arranged. The top of each protrusion portion is arc-shaped. As described above, the corrugated structure of the corrugated portion has the alternately arranged protrusion portions and flat portions, which can significantly reduce scattering phenomena in order to minimize the loss of light passing through the corrugated portion. Therefore, the light efficiency of the light tube can be further improved to meet actual requirements.
(5) In one embodiment of the present invention, the first light adjustment portion and the second light adjustment portion of the inner tube of the light tube are inclined surfaces, while the corrugated portion is arc-shaped. Additionally, the first upper plane of each first prism step is parallel to the vertical reference plane, and the first lower plane of each first prism step is parallel to the horizontal reference plane. The second upper plane of each second prism step is parallel to the vertical reference plane, and the second lower plane of each second prism step is parallel to the horizontal reference plane. As such, the first light adjustment portion and the second light adjustment portion can take on a stair-like shape. The aforementioned structural design enhances the light concentration function so as to improve the illuminance in a specific direction (the direction of the corrugated portion). Therefore, the lighting effect of the light tube can be further improved.
(6) In one embodiment of the present invention, the light tube can achieve the aforementioned multi-layer optical medium structure via a simple structural design. This multi-layer optical medium structure effectively improves the light efficiency, lighting effect, and visual effect of the light tube. As a result, the light tube can achieve the desired functions without significantly increasing costs, enhancing the practicality thereof and meeting the requirements of different applications. As a result, the light tube can conform to future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a perspective view of a light tube with a multi-layer optical medium structure in accordance with a first embodiment of the present invention.

FIG. 2 is a sectional view of the light tube with the multi-layer optical medium structure in accordance with the first embodiment of the present invention.

FIG. 3 is a schematic view of a first prism step of a first light adjustment portion of the light tube with the multi-layer optical medium structure in accordance with the first embodiment of the present invention.

FIG. 4 is a schematic view of a corrugated structure of a corrugated portion of the light tube with the multi-layer optical medium structure in accordance with the first embodiment of the present invention.

FIG. 5 is a schematic view of an operating state of a light tube with a multi-layer optical medium structure in accordance with a second embodiment of the present invention.

FIG. 6 is a sectional view of a light tube with a multi-layer optical medium structure in accordance with a third embodiment of the present invention.

FIG. 7 is a schematic view of an operating state of the light tube with the multi-layer optical medium structure in accordance with the third embodiment of the present invention.

FIG. 8 is a sectional view of the light tube with the multi-layer optical medium structure in accordance with a fourth embodiment of the present invention.

FIG. 9 is a schematic view of a first prism step of a first light adjustment portion of the light tube with the multi-layer optical medium structure in accordance with the fourth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

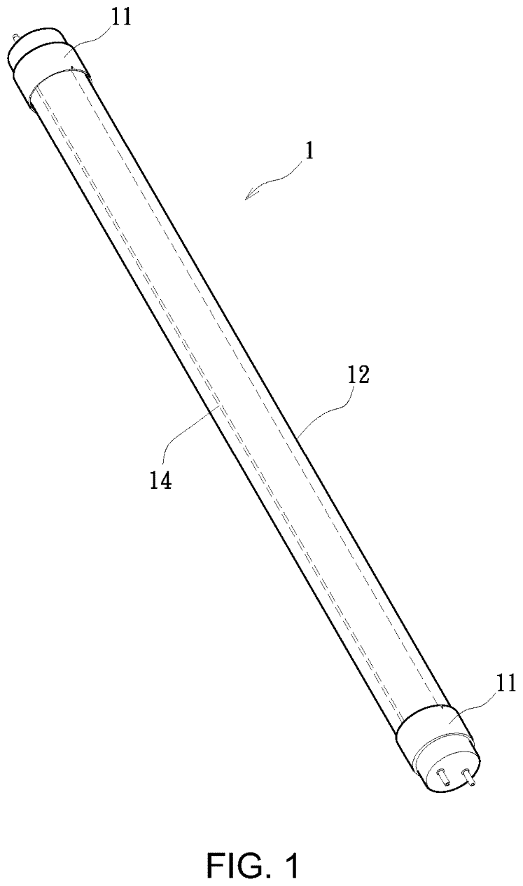

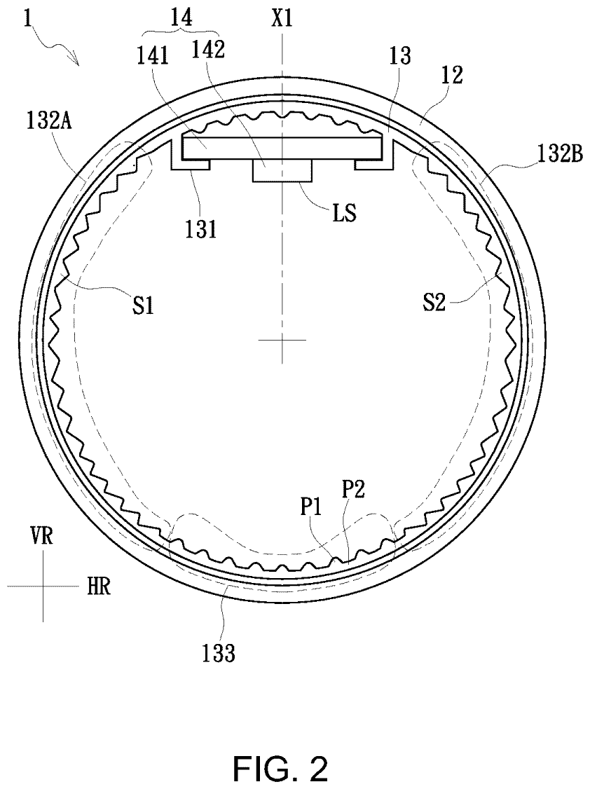

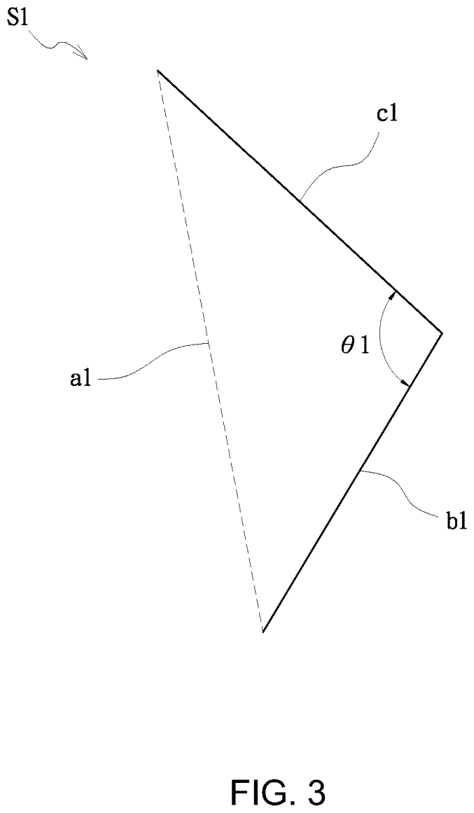

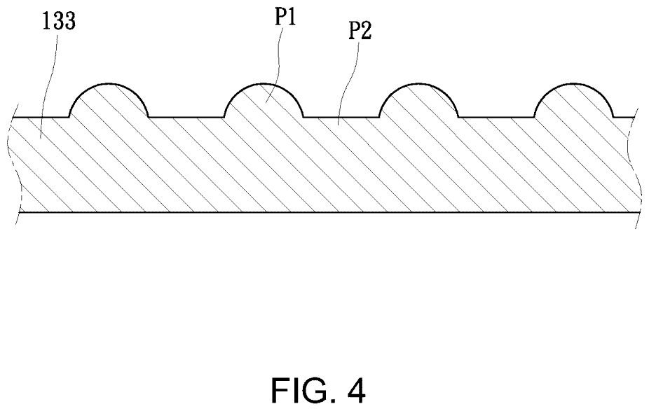

Please refer to FIG. 1, FIG. 2, FIG. 3 and FIG. 4. FIG. 1 is a perspective view of a light tube with a multi-layer optical medium structure in accordance with a first embodiment of the present invention. FIG. 2 is a sectional view of the light tube with the multi-layer optical medium structure in accordance with the first embodiment of the present invention. FIG. 3 is a schematic view of a first prism step of a first light adjustment portion of the light tube with the multi-layer optical medium structure in accordance with the first embodiment of the present invention. FIG. 4 is a schematic view of a corrugated structure of a corrugated portion of the light tube with the multi-layer optical medium structure in accordance with the first embodiment of the present invention. As shown in FIG. 1, FIG. 2, FIG. 3 and FIG. 4, the light tube 1 includes two end caps 11, an outer tube 12, an inner tube 13, and a light source board 14.

The outer tube 12 is cylindrical. In this embodiment, the outer tube 12 may be made of glass. In another embodiment, the outer tube 12 may be made of plastic or other transparent or translucent materials.

The inner tube 13 is disposed inside the outer tube 12. The inner tube 13 includes a mounting base 131, a first light adjustment portion 132A, a second light adjustment portion 132B, and a corrugated portion 133. The mounting base 131, the first light adjustment portion 132A, and the second light adjustment portion 132B are arranged on the inner wall of the inner tube 13. The corrugated portion 133 is disposed between the first light adjustment portion 132A and the second light adjustment portion 132B. The mounting base 131 is also disposed between the first light adjustment portion 132A and the second light adjustment portion 132B, and is opposite to the corrugated portion 133. Thus, the corrugated portion 133 is corresponding to one side of the light source board 14 (the corrugated portion 133 is opposite to the light-emitting surface LS of the light source board 14). In this embodiment, the inner tube 13 may be made of glass and includes a diffusing agent. In another embodiment, the inner tube 13 may be made of plastic or other transparent or translucent materials.

The light source board 14 is disposed on the mounting base 131 of the inner tube 13, and includes a circuit board 141 and a plurality of light-emitting diodes 142 (only one is shown in the figure).

The two end caps 11 are respectively disposed at both ends of the outer tube 12. One of the end caps 11 may include a power module (not shown in the figure), which can be connected to the light source board 14 to drive the light source board 14. The circuit structure of the power module should be well-known to those skilled in the art and will not be described in detail here.

The inner tube 13 has a special optical structural design. The first light adjustment portion 132A and the second light adjustment portion 132B are arc-shaped. The first light adjustment portion 132A has a plurality of first prism steps S1 arranged in sequence. The second light adjustment portion 132B has a plurality of second prism steps S2 arranged in sequence. Each first prism step S1 has a first upper plane c1, a first lower plane b1, and a bottom surface a1 connected to each other (in this embodiment, the edge of the first prism step S1 farthest from the light source board 14 is defined as the bottom surface a1, while the other two edges are defined as the first upper plane c1 and the first lower plane b1). The distance between the first upper plane c1 and the light source board 14 is less than the distance between the first lower plane b1 and the light source board 14. Similarly, each second prism step S2 has a second upper plane and a second lower plane connected to each other, and the distance between the second upper plane and the light source board 14 is smaller than the distance between the second lower plane and the light source board 14. The first upper plane c1 is not parallel to the vertical reference plane VR, and the first lower plane b1 is not parallel to the horizontal reference plane HR. The second upper plane is not parallel to the vertical reference plane VR, and the second lower plane is not parallel to the horizontal reference plane HR (the vertical reference plane VR is perpendicular to the light-emitting surface LS of the light source board 14, and the horizontal reference plane HR is parallel to the light-emitting surface LS of the light source board 14). The angle of the corner (which faces toward the central axis X1 of the light source board 14) of the first prism step S1 is greater than 90° (θ1>90°). The structure of the first prism step S1 is the same as that of the second prism step S2, so this embodiment only describes the structure of the first prism step S1.

The corrugated portion 133 has a corrugated structure and is arc-shaped. In this embodiment, the corrugated portion 133 is disposed on the inner wall of the inner tube 13. In another embodiment, the corrugated portion 133 may also be disposed on the outer wall of the inner tube 13. In yet another embodiment, the corrugated portion 133 may also be arranged on both the outer wall and the inner wall of the inner tube 13. The corrugated structure includes a plurality of protrusion portions P1 and a plurality of flat portions P2. The plurality of protrusion portions P1 and the plurality of flat portions P2 are alternately arranged. The top of each protrusion portion P1 is arc-shaped. In this embodiment, the width of the protrusion portion P1 may be equal to the width of the flat portion P2. In another embodiment, the width of the protrusion portion P1 may be greater than the width of the flat portion P2. In yet another embodiment, the width of the protrusion portion P1 may be smaller than the width of the flat portion P2, or the corrugated structure may only include a plurality of protrusion portions P1 without including flat portions P2.

Only a small portion of the light emitted by the light source board 14 passes through the upper part of the first light adjustment portion 132A and the second light adjustment portion 132B. The first prism steps S1 of the first light adjustment portion 132A and the second prism steps S2 of the second light adjustment portion 132B can effectively elongate the light spots generated by the light, which can prevent the user from experiencing glare or other discomfort caused by the light spots. A portion of the light emitted by the light source board 14 passes through the lower part of the first light adjustment portion 132A and the second light adjustment portion 132B. The first prism steps S1 of the first light adjustment portion 132A and the second prism steps S2 of the second light adjustment portion 132B can also effectively elongate the light spots generated by the light. At the same time, the first prism steps S1 of the first light adjustment portion 132A and the second prism steps S2 of the second light adjustment portion 132B can effectively concentrate the light emitted by the light source board 14 toward the direction of the corrugated portion 133 through refraction. Most of the light emitted by the light source board 14 passes through the corrugated portion 133. The corrugated structure of the corrugated portion 133 has the alternately arranged protrusion portions P1 and flat portions P2, which can significantly reduce scattering phenomena in order to minimize the loss of light passing through the corrugated portion 133. Additionally, the aforementioned corrugated structure can also diffuse the light evenly, making the light distribution more uniform. After passing through the inner tube 13, the light emitted by the light source board 14 passes through the outer tube 12, which can further concentrate the light emitted by the light source board 14 toward the direction of the corrugated portion 133 through refraction.

From the above, it can be seen that in this embodiment, the first light adjustment portion 132A and the second light adjustment portion 132B of the inner tube 13 of the light tube 1 have the special structural design. The first light adjustment portion 132A has the first prism steps S1 arranged in sequence, and the second light adjustment portion 132B has the second prism steps S2 arranged in sequence. Each first prism step S1 has the first upper plane c1 and the first lower plane b1 connected to each other. The distance between the first upper plane c1 and the light source board 14 is less than the distance between the first lower plane b1 and the light source board 14. Each second prism step S2 has a second upper plane and a second lower plane connected to each other. The distance between the second upper plane and the light source board 14 is less than the distance between the second lower plane and the light source board 14. The structural design of the first light adjustment portion 132A and the second light adjustment portion 132B can effectively concentrate the light emitted by the light source board 14 toward the direction of the corrugated portion 133 with a view to improving the light efficiency of the light tube 1. Therefore, the performance of the light tube 1 is significantly enhanced.

Furthermore, in this embodiment, the first light adjustment portion 132A and the second light adjustment portion 132B of the inner tube 13 of the light tube 1 have the special structural design, making them serrated in shape. This design can effectively elongate the light spots generated by the light emitted from the light source board 14, which can prevent the user from experiencing glare or other discomfort caused by the light spots. Therefore, the visual effect of the light from the light tube 1 is greatly improved so as to effectively enhance the comfort of the environment. As a result, the application of the light tube 1 can be more comprehensive and more flexible in use.

Additionally, in this embodiment, the corrugated portion 133 of the inner tube 13 of the light tube 1 has the corrugated structure, which includes the protrusion portions P1 and the flat portions P2. The aforementioned protrusion portions P1 and flat portions P2 are alternately arranged. The top of each protrusion portion P1 is arc-shaped. As described above, the corrugated structure of the corrugated portion 133 has the alternately arranged protrusion portions P1 and flat portions P2, which can significantly reduce scattering phenomena in order to minimize the loss of light passing through the corrugated portion 133. Therefore, the light efficiency of the light tube 1 can be further improved to meet the requirements of practical applications.

Thus, the light tube 1 can achieve the aforementioned multi-layer optical medium structure (the combination of the outer tube 12 and the inner tube 13) through a simple structural design. Additionally, the first light adjustment portion 132A of the inner tube 13 has the first prism steps S1 arranged in sequence, and the second light adjustment portion 132B of the inner tube 13 has the second prism steps S2 arranged in sequence. The corrugated portion 133 of the inner tube 13 has the corrugated structure. In this way, the structural design of the inner tube 13 is a multifunctional composite microstructure design. Therefore, the aforementioned multi-layer optical medium structure can effectively improve the light efficiency, lighting effect, and visual effect of the light tube 1.

The embodiment just exemplifies the present invention and is not intended to limit the scope of the present invention; any equivalent modification and variation according to the spirit of the present invention is to be also included within the scope of the following claims and their equivalents.

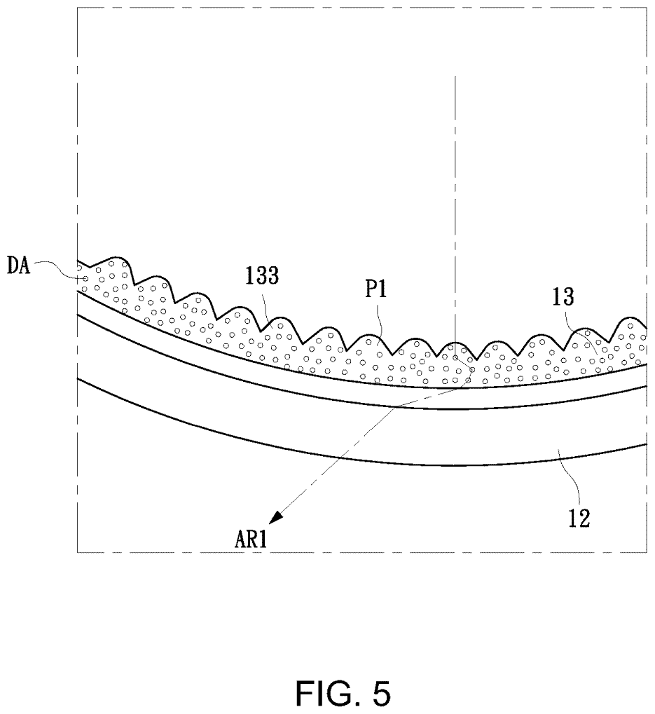

Please refer to FIG. 5, which is a schematic view of an operating state of a light tube with a multi-layer optical medium structure in accordance with a second embodiment of the present invention. As shown in FIG. 5, in this embodiment, the corrugated structure of the corrugated portion 133 of the inner tube 13 only has protrusion portions P1. When the light passes through the corrugated portion 133 of the inner tube 13, the light is refracted by the corrugated portion 133 and the diffusing agent DA inside the corrugated portion 133. At the same time, the corrugated portion 133 can significantly reduce scattering phenomena in order to minimize the loss of light passing through the corrugated portion 133. Then, when the light passes through the outer tube 12, the outer tube 12 can further concentrate the light emitted by the light source board 14 toward the direction of the corrugated portion 133 through refraction. The path of the light is shown by the arrow AR1 in FIG. 5.

The embodiment just exemplifies the present invention and is not intended to limit the scope of the present invention; any equivalent modification and variation according to the spirit of the present invention is to be also included within the scope of the following claims and their equivalents.

It is worthy to point out that currently available light tubes adopt a single-layer optical medium structure (single-layer light cover) without any additional optical adjustment mechanisms, so these light tubes still have many shortcomings that need to be addressed. For example, currently available light tubes are prone to producing severe light spots, which reduces the lighting effectiveness thereof. Additionally, due to factors such as structural design, currently available light tubes are susceptible to reduced light efficiency caused by scattering. By contrast, according to one embodiment of the present invention, the light tube includes an outer tube, an inner tube and a light source board. The inner tube is disposed inside the outer tube, and includes a mounting base, a first light adjustment portion, a second light adjustment portion, and a corrugated portion. The mounting base, the first light adjustment portion, and the second light adjustment portion are disposed on then inner wall of the inner tube, and the corrugated portion and the mounting base are disposed between the first light adjustment portion and the second light adjustment portion. The light source board is disposed on the mounting base. The corrugated portion is corresponding to one side of the light source board. The first light adjustment portion has a plurality of first prism steps arranged in sequence, the second light adjustment portion has a plurality of second prism steps arranged in sequence, and the corrugated portion has a corrugated structure. As described above, the light tube includes the outer tube and the embedded inner tube to form a multi-layer optical medium structure (double-layer light cover). This multi-layer optical medium structure allows the light emitted by the light source board to undergo two refractions, thereby achieving light concentration. This effectively enhances the illuminance in a specific direction (the direction of the corrugated portion) so as to significantly improve the lighting effect of the light tube. The aforementioned corrugated structure also enables uniform diffusion of light, so the light distribution can be more even.

According to one embodiment of the present invention, the first light adjustment portion and the second light adjustment portion of the inner tube of the light tube have a special structural design. The first light adjustment portion has a plurality of first prism steps arranged in sequence, and the second light adjustment portion has a plurality of second prism steps arranged in sequence. Each first prism step has a first upper plane and a first lower plane connected to each other. The distance between the first upper plane and the light source board is less than the distance between the first lower plane and the light source board. Each second prism step has a second upper plane and a second lower plane connected to each other. The distance between the second upper plane and the light source board is less than the distance between the second lower plane and the light source board. The structural design of the first light adjustment portion and the second light adjustment portion effectively concentrates the light emitted by the light source board toward the direction of the corrugated portion with a view to improving the light efficiency of the light tube. As a result, the performance of the light tube is significantly enhanced.

Also, according to one embodiment of the present invention, the first light adjustment portion and the second light adjustment portion of the inner tube of the light tube have a special structural design, making them serrated in shape. This design effectively elongates the light spots generated by the light emitted from the light source board, preventing users from experiencing glare or other discomfort caused by the light spots. Therefore, the visual effect of the light from the light tube is greatly improved, which can effectively enhance the comfort of the environment. Thus, the light tube can be more comprehensive in application and more flexible in use.

Further, according to one embodiment of the present invention, the corrugated portion of the inner tube of the light tube has the corrugated structure, which includes a plurality of protrusion portions and a plurality of flat portions. The aforementioned protrusion portions and flat portions are alternately arranged. The top of each protrusion portion is arc-shaped. As described above, the corrugated structure of the corrugated portion has the alternately arranged protrusion portions and flat portions, which can significantly reduce scattering phenomena in order to minimize the loss of light passing through the corrugated portion. Therefore, the light efficiency of the light tube can be further improved to meet actual requirements.

Moreover, according to one embodiment of the present invention, the first light adjustment portion and the second light adjustment portion of the inner tube of the light tube are inclined surfaces, while the corrugated portion is arc-shaped. Additionally, the first upper plane of each first prism step is parallel to the vertical reference plane, and the first lower plane of each first prism step is parallel to the horizontal reference plane. The second upper plane of each second prism step is parallel to the vertical reference plane, and the second lower plane of each second prism step is parallel to the horizontal reference plane. As such, the first light adjustment portion and the second light adjustment portion can take on a stair-like shape. The aforementioned structural design enhances the light concentration function so as to improve the illuminance in a specific direction (the direction of the corrugated portion). Therefore, the lighting effect of the light tube can be further improved.

Furthermore, according to one embodiment of the present invention, the light tube can achieve the aforementioned multi-layer optical medium structure via a simple structural design. This multi-layer optical medium structure effectively improves the light efficiency, lighting effect, and visual effect of the light tube. As a result, the light tube can achieve the desired functions without significantly increasing costs, enhancing the practicality thereof and meeting the requirements of different applications. As a result, the light tube can conform to future development trends. As previously stated, the light tube with the multi-layer optical medium structure according to the embodiments of the present invention can achieve great technical effects.

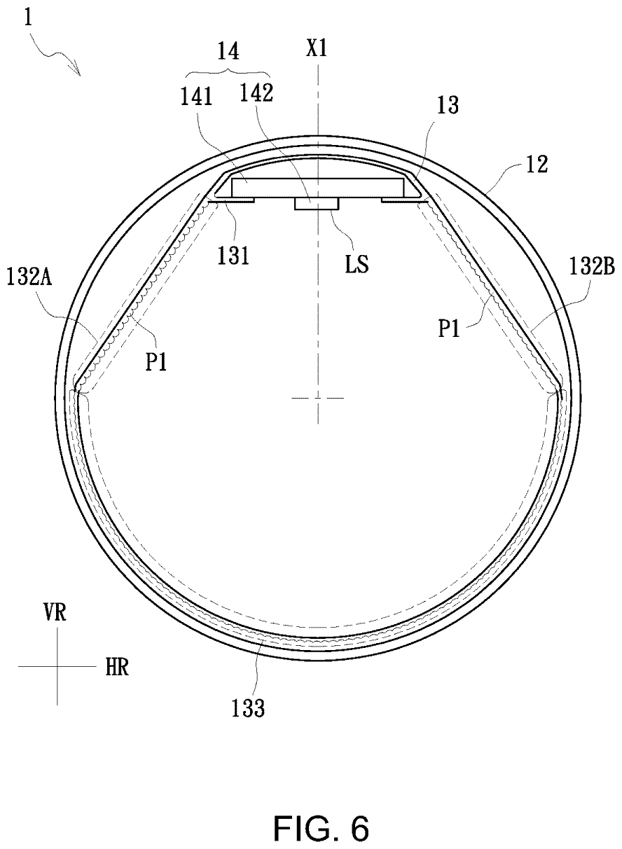

Please refer to FIG. 6, which is a sectional view of a light tube with a multi-layer optical medium structure in accordance with a third embodiment of the present invention. Please also refer to FIG. 1. As shown in FIG. 6, the light tube 1 includes two end caps 11, an outer tube 12, an inner tube 13, and a light source board 14.

The outer tube 12 is cylindrical. The inner tube 13 is disposed inside the outer tube 12. The inner tube 13 includes a mounting base 131, a first light adjustment portion 132A, a second light adjustment portion 132B, and a corrugated portion 133. The mounting base 131, the first light adjustment portion 132A, and the second light adjustment portion 132B are disposed on the inner wall of the inner tube 13. The corrugated portion 133 is disposed between the first light adjustment portion 132A and the second light adjustment portion 132B. The mounting base 131 is also disposed between the first light adjustment portion 132A and the second light adjustment portion 132B, and is opposite to the corrugated portion 133. Thus, the corrugated portion 133 is corresponding to one side of the light source board 14 (the corrugated portion 133 is opposite to the light-emitting surface LS of the light source board 14).

The light source board 14 is mounted on the mounting base 131 of the inner tube 13, and includes a circuit board 141 and a plurality of light-emitting diodes 142.

The two end caps 11 are respectively disposed at both ends of the outer tube 12. One of the end caps 11 may include a power module (not shown in FIG. 6), which can be connected to the light source board 14 to drive the light source board 14.

The aforementioned components are similar to those in the previous embodiments, so they will not be described in detail here. The difference between this embodiment and the previous embodiments is that the inner tube 13, in this embodiment, has a different optical structural design. The first light adjustment portion 132A and the second light adjustment portion 132B are inclined surfaces. The first light adjustment portion 132A has a corrugated structure. The second light adjustment portion 132B also has a corrugated structure.

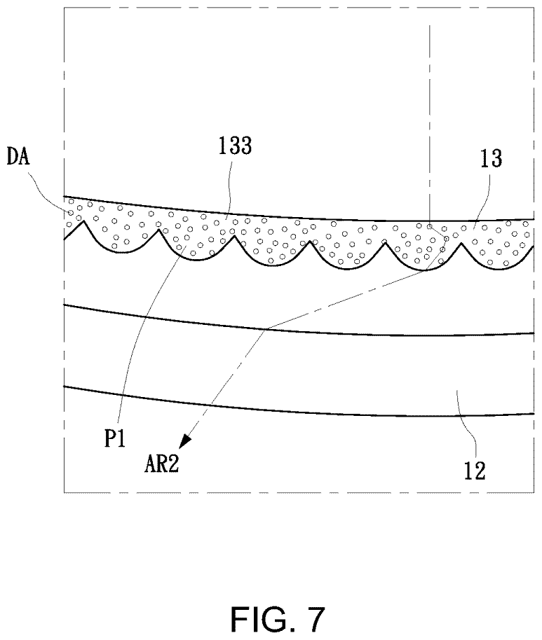

The corrugated portion 133 has a corrugated structure and is arc-shaped. In this embodiment, the corrugated portion 133 is disposed on the outer wall of the inner tube 13. The corrugated structure in this embodiment only includes a plurality of protrusion portions P1 and does not include flat portions P2 (the corrugated structure in this embodiment is shown in FIG. 7 instead of FIG. 6). In another embodiment, the corrugated portion 133 may also be disposed on the inner wall of the inner tube 13.

As described above, the first light adjustment portion 132A and the second light adjustment portion 132B are inclined surfaces, which can effectively concentrate the light emitted by the light source board 14 toward the direction of the corrugated portion 133 with a view to improving the light efficiency of the light tube 1. At the same time, the first light adjustment portion 132A and the second light adjustment portion 132B can also effectively elongate the light spots generated by the light emitted from the light source board 14 and significantly reduce scattering phenomena. Similarly, the corrugated structure of the corrugated portion 133 can also significantly reduce scattering phenomena in order to minimize the loss of light passing through the corrugated portion 133. Therefore, the light efficiency of the light tube 1 can be further improved to meet actual requirements.

The embodiment just exemplifies the present invention and is not intended to limit the scope of the present invention; any equivalent modification and variation according to the spirit of the present invention is to be also included within the scope of the following claims and their equivalents.

Please refer to FIG. 7, which is a schematic view of an operating state of the light tube with the multi-layer optical medium structure in accordance with the third embodiment of the present invention. As shown in FIG. 7, in this embodiment, the corrugated structure of the corrugated portion 133 of the inner tube 13 only has protrusion portions P1. When the light passes through the corrugated portion 133 of the inner tube 13, the light is refracted by the corrugated portion 133 and the diffusing agent DA inside the corrugated portion 133. At the same time, the corrugated portion 133 can significantly reduce scattering phenomena in order to minimize the loss of light passing through the corrugated portion 133. Then, when the light passes through the outer tube 12, the outer tube 12 can further concentrate the light emitted by the light source board 14 toward the direction of the corrugated portion 133 through refraction. The path of the light is shown by the arrow AR2 in FIG. 7.

The embodiment just exemplifies the present invention and is not intended to limit the scope of the present invention; any equivalent modification and variation according to the spirit of the present invention is to be also included within the scope of the following claims and their equivalents.

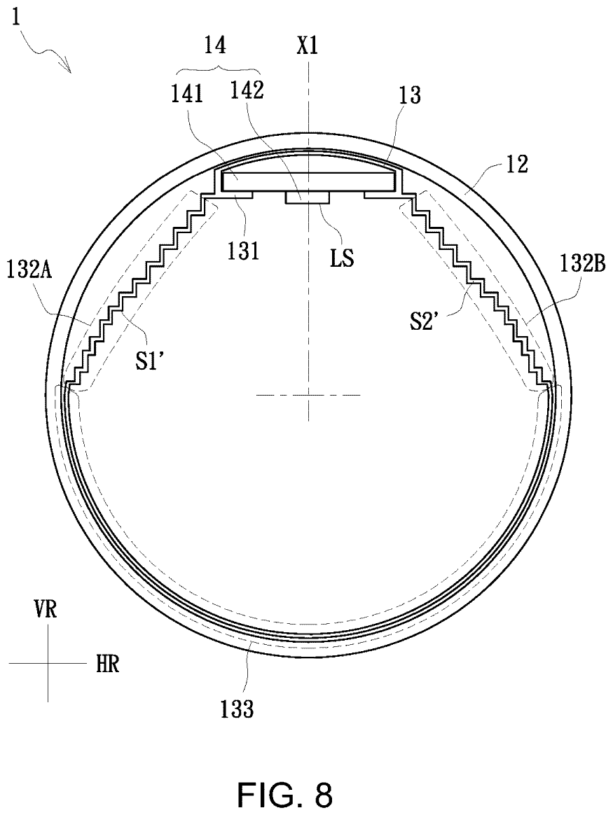

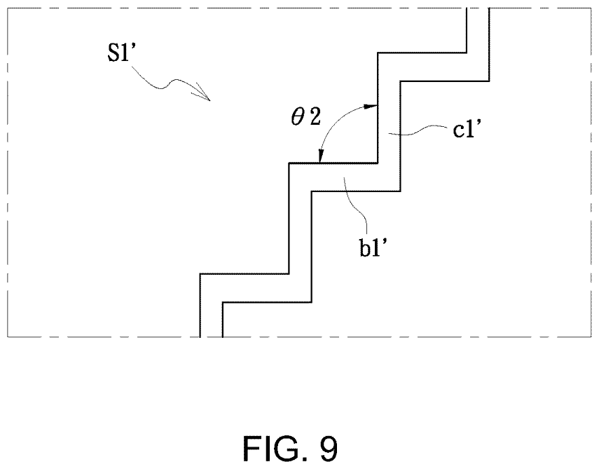

Please refer to FIG. 8 and FIG. 9. FIG. 8 is a sectional view of the light tube with the multi-layer optical medium structure in accordance with a fourth embodiment of the present invention. FIG. 9 is a schematic view of a first prism step of a first light adjustment portion of the light tube with the multi-layer optical medium structure in accordance with the fourth embodiment of the present invention. Please refer to FIG. 1 and FIG. 5. As shown in FIG. 8 and FIG. 9, the light tube 1 includes two end caps 11, an outer tube 12, an inner tube 13, and a light source board 14.

The outer tube 12 is cylindrical. The inner tube 13 is disposed inside the outer tube 12. The inner tube 13 includes a mounting base 131, a first light adjustment portion 132A, a second light adjustment portion 132B, and a corrugated portion 133. The mounting base 131, the first light adjustment portion 132A, and the second light adjustment portion 132B are disposed on the inner wall of the inner tube 13. The corrugated portion 133 is disposed between the first light adjustment portion 132A and the second light adjustment portion 132B. The mounting base 131 is also disposed between the first light adjustment portion 132A and the second light adjustment portion 132B, and is opposite to the corrugated portion 133. Thus, the corrugated portion 133 is corresponding to one side of the light source board 14 (the corrugated portion 133 is opposite to the light-emitting surface LS of the light source board 14).

The light source board 14 is mounted on the mounting base 131 of the inner tube 13, and includes a circuit board 141 and a plurality of light-emitting diodes 142.

The two end caps 11 are respectively disposed at both ends of the outer tube 12. One of the end caps 11 may include a power module (not shown in the figure), which can be connected to the light source board 14 to drive the light source board 14.

The aforementioned components are similar to those in the previous embodiments, so they will not be described in detail here. The difference between this embodiment and the previous embodiments is that the inner tube 13 in this embodiment has a different optical structural design. The first light adjustment portion 132A and the second light adjustment portion 132B are inclined surfaces. The first light adjustment portion 132A has a plurality of first prism steps S1′ arranged in sequence. The second light adjustment portion 132B has a plurality of second prism steps S2′ arranged in sequence. Each first prism step S1′ has a first upper plane c1′ and a first lower plane b1′ connected to each other. The distance between the first upper plane c1′ and the light source board 14 is less than the distance between the first lower plane b1′ and the light source board 14. Similarly, each second prism step S2′ has a second upper plane and a second lower plane connected to each other. The distance between the second upper plane and the light source board 14 is less than the distance between the second lower plane and the light source board 14. The angle of the corner (which faces toward the central axis X1 of the light source board 14) of the first prism step S1′ toward the central axis X1 of the light source board 14 is equal to 90° (θ2=90°). The structure of the first prism step S1′ is the same as that of the second prism step S2′, so this embodiment only describes the structure of the first prism step S1′.

The corrugated portion 133 has a corrugated structure and is arc-shaped. In this embodiment, the corrugated portion 133 is disposed on the inner wall of the inner tube 13. The corrugated structure in this embodiment only includes a plurality of protrusion portions P1 and does not include flat portions P2 (the corrugated structure in this embodiment is not shown in FIG. 8; the corrugated structure in this embodiment is the same as that in FIG. 5). In another embodiment, the corrugated portion 133 may also be arranged on the outer wall of the inner tube 13.

As set forth above, the first light adjustment portion 132A and the second light adjustment portion 132B of the inner tube 13 of the light tube 1 are inclined surfaces, and the corrugated portion 133 is arc-shaped. Additionally, the first upper plane c1′ of each first prism step S1′ is parallel to the vertical reference plane VR, and the first lower plane b1′ of each first prism step S1′ is parallel to the horizontal reference plane HR. The second upper plane of each second prism step S2′ is parallel to the vertical reference plane VR, and the second lower plane of each second prism step S2′ is parallel to the horizontal reference plane HR. In this way, the first light adjustment portion 132A and the second light adjustment portion 132B can take on a stair-like shape. The aforementioned structural design enhances the light concentration function, further improving the illuminance in a specific direction (the direction of the corrugated portion 133) in order to further enhance the lighting effect of the light tube 1.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the light tube includes an outer tube, an inner tube and a light source board. The inner tube is disposed inside the outer tube, and includes a mounting base, a first light adjustment portion, a second light adjustment portion, and a corrugated portion. The mounting base, the first light adjustment portion, and the second light adjustment portion are disposed on then inner wall of the inner tube, and the corrugated portion and the mounting base are disposed between the first light adjustment portion and the second light adjustment portion. The light source board is disposed on the mounting base. The corrugated portion is corresponding to one side of the light source board. The first light adjustment portion has a plurality of first prism steps arranged in sequence, the second light adjustment portion has a plurality of second prism steps arranged in sequence, and the corrugated portion has a corrugated structure. As described above, the light tube includes the outer tube and the embedded inner tube to form a multi-layer optical medium structure (double-layer light cover). This multi-layer optical medium structure allows the light emitted by the light source board to undergo two refractions, thereby achieving light concentration. This effectively enhances the illuminance in a specific direction (the direction of the corrugated portion) so as to significantly improve the lighting effect of the light tube. The aforementioned corrugated structure also enables uniform diffusion of light, so the light distribution can be more even.

According to one embodiment of the present invention, the first light adjustment portion and the second light adjustment portion of the inner tube of the light tube have a special structural design. The first light adjustment portion has a plurality of first prism steps arranged in sequence, and the second light adjustment portion has a plurality of second prism steps arranged in sequence. Each first prism step has a first upper plane and a first lower plane connected to each other. The distance between the first upper plane and the light source board is less than the distance between the first lower plane and the light source board. Each second prism step has a second upper plane and a second lower plane connected to each other. The distance between the second upper plane and the light source board is less than the distance between the second lower plane and the light source board. The structural design of the first light adjustment portion and the second light adjustment portion effectively concentrates the light emitted by the light source board toward the direction of the corrugated portion with a view to improving the light efficiency of the light tube. As a result, the performance of the light tube is significantly enhanced.

Also, according to one embodiment of the present invention, the first light adjustment portion and the second light adjustment portion of the inner tube of the light tube have a special structural design, making them serrated in shape. This design effectively elongates the light spots generated by the light emitted from the light source board, preventing users from experiencing glare or other discomfort caused by the light spots. Therefore, the visual effect of the light from the light tube is greatly improved, which can effectively enhance the comfort of the environment. Thus, the light tube can be more comprehensive in application and more flexible in use.

Further, according to one embodiment of the present invention, the corrugated portion of the inner tube of the light tube has the corrugated structure, which includes a plurality of protrusion portions and a plurality of flat portions. The aforementioned protrusion portions and flat portions are alternately arranged. The top of each protrusion portion is arc-shaped. As described above, the corrugated structure of the corrugated portion has the alternately arranged protrusion portions and flat portions, which can significantly reduce scattering phenomena in order to minimize the loss of light passing through the corrugated portion. Therefore, the light efficiency of the light tube can be further improved to meet actual requirements.

Moreover, according to one embodiment of the present invention, the first light adjustment portion and the second light adjustment portion of the inner tube of the light tube are inclined surfaces, while the corrugated portion is arc-shaped. Additionally, the first upper plane of each first prism step is parallel to the vertical reference plane, and the first lower plane of each first prism step is parallel to the horizontal reference plane. The second upper plane of each second prism step is parallel to the vertical reference plane, and the second lower plane of each second prism step is parallel to the horizontal reference plane. As such, the first light adjustment portion and the second light adjustment portion can take on a stair-like shape. The aforementioned structural design enhances the light concentration function so as to improve the illuminance in a specific direction (the direction of the corrugated portion). Therefore, the lighting effect of the light tube can be further improved.

Furthermore, according to one embodiment of the present invention, the light tube can achieve the aforementioned multi-layer optical medium structure via a simple structural design. This multi-layer optical medium structure effectively improves the light efficiency, lighting effect, and visual effect of the light tube. As a result, the light tube can achieve the desired functions without significantly increasing costs, enhancing the practicality thereof and meeting the requirements of different applications. As a result, the light tube can conform to future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light tube with a multi-layer optical medium structure, comprising:
an outer tube;
an inner tube disposed inside the outer tube, and comprising a mounting base, a first light adjustment portion, a second light adjustment portion, and a corrugated portion, wherein the mounting base, the first light adjustment portion, and the second light adjustment portion are disposed on an inner wall of the inner tube, and the corrugated portion and the mounting base are disposed between the first light adjustment portion and the second light adjustment portion; and
a light source board disposed on the mounting base, wherein the corrugated portion is corresponding to one side of the light source board;
wherein the first light adjustment portion has a plurality of first prism steps arranged in sequence, the second light adjustment portion has a plurality of second prism steps arranged in sequence, and the corrugated portion has a corrugated structure.

2. The light tube with the multi-layer optical medium structure as claimed in claim 1, wherein the outer tube is cylindrical.

3. The light tube with the multi-layer optical medium structure as claimed in claim 1, wherein the corrugated portion is disposed on the inner wall or an outer wall of the inner tube.

4. The light tube with the multi-layer optical medium structure as claimed in claim 1, wherein the corrugated portion is disposed on both the inner wall and an outer wall of the inner tube.

5. The light tube with the multi-layer optical medium structure as claimed in claim 1, wherein the corrugated structure comprises a plurality of protrusion portions, and a top of each of the protrusion portions is arc-shaped.

6. The light tube with the multi-layer optical medium structure as claimed in claim 5, wherein the corrugated structure further comprises a plurality of flat portions, and the protrusion portions and the flat portions are alternately arranged.

7. The light tube with the multi-layer optical medium structure as claimed in claim 1, wherein each of the first prism steps has a first upper plane and a first lower plane connected to each other, wherein a distance between the first upper plane and the light source board is less than a distance between the first lower plane and the light source board, and each of the second prism steps has a second upper plane and a second lower plane connected to each other, wherein a distance between the second upper plane and the light source board is less than a distance between the second lower plane and the light source board.

8. The light tube with the multi-layer optical medium structure as claimed in claim 7, wherein the first upper plane is parallel to a vertical reference plane, the first lower plane is parallel to a horizontal reference plane, the second upper plane is parallel to the vertical reference plane, and the second lower plane is parallel to the horizontal reference plane.

9. The light tube with the multi-layer optical medium structure as claimed in claim 7, wherein the first upper plane is not parallel to a vertical reference plane, the first lower plane is not parallel to a horizontal reference plane, the second upper plane is not parallel to the vertical reference plane, and the second lower plane is not parallel to the horizontal reference plane.

10. The light tube with the multi-layer optical medium structure as claimed in claim 1, wherein the first light adjustment portion and the second light adjustment portion are inclined surfaces, and the corrugated portion is arc-shaped.
